(19) United States
(12) Patent Application Publication
(10) Pub. No.: US 2003/0070313 A1
(43) Pub. Date: Apr. 17, 2003

(54) Heart shaped envelope maker and method of use

(76) Inventor: Nicholas K. Romer, Flemington, NJ (US)

Correspondence Address: HENDERSON & STURM LLP, 1213 MIDLAND BUILDING, 206 SIXTH AVENUE, DES MOINES, IA, 50309-4076, US

(21) Appl. No.: 09/975,116

(22) Filed: Oct. 11, 2001

(51) Int. Cl. B43L 7/00

(52) U.S. Cl. 33/566

(57) ABSTRACT

A method and apparatus for making differently configured paper receptacles such as envelopes from a sheet of paper (50) using a template unit (100) and a severing implement (80) to create a generally cruciform shaped envelope blank having a square central section (51) and four rounded arm flaps (52) through (55) that project outwardly from the arm flaps (52) through (55) wherein particular sequences of creasing and folding steps will produce: a heart shaped paper receptacle; an ice cream cone or balloon shaped paper receptacle; and a square envelope whose rear face represents a “yin yan” symbol.

### CROSS REFERENCE TO RELATED APPLICATIONS

Not applicable.

### BACKGROUND OF THE INVENTION

1. Field of the Invention

The present invention relates to the field of envelope making and in particular to a method and apparatus for making heart shaped envelopes.

2. Description of Related Art

As can be seen by reference to the following U.S. Pat. Nos. 5,626,551; 5,685,816; 4,421,500; 4,936,020, the prior art is replete with myriad and diverse arrangements for making folded paper articles such as envelopes.

While all of the aforementioned prior art constructions are more than adequate for the basic purpose and function for which they have been specifically designed, they are uniformly deficient with respect to their failure to provide a simple, efficient, and practical method of making a heart shaped envelope.

Given the significance of a valentine shaped heart, it is rather surprising that to date no one has developed a method and apparatus for creating an envelope having a generally conventional rectangular front face yet whose flaps are configured to produce a heart shaped configuration when the envelope is opened by the recipients.

As a consequence of the foregoing situation, there has existed a longstanding need among lovers, parents, spouses and kin for a new and improved envelope which produces a heart shaped receptacle when opened to signify love and affection toward the recipient; and the provision of such a method and apparatus is the stated objective of the present invention.

### BRIEF SUMMARY OF THE INVENTION

Briefly stated, the heart shaped envelope maker that forms the basis of this invention comprises a template unit capable of producing a generally cruciform shaped tracing on a sheet of paper wherein the cruciform outline is removed from the sheet of paper by severing to produce a cruciform shaped envelope blank.

As will be explained in greater detail further on in the specification, the crucial aspect of this invention revolves around the fact that the generally cruciform shape of the envelope blank produced by the template unit has four mirror image rounded arm flaps spaced equidistant from the center of a square central section of the envelope blank which results in a heart shaped configuration when two adjacent arm flaps are folded against the square central section of the envelope blank which results in a heart shaped configuration when two adjacent arm flaps are folded against the square central section.

In addition, the template unit may comprise either a positive or negative cruciform shaped template member or a curved discontinuous slotted template member to produce the cruciform shaped tracing that is required for the envelope blank that embodies the teachings of this invention.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is an exploded perspective view of both the positive and negative versions of the basic template;

FIG. 2 is an illustration of the tracing step using the positive template;

FIG. 3 is an illustration of the tracing step using the negative template;

FIG. 4 is a top plan view of one preferred version of the positive template;

FIG. 5 is a top plan view of an unfolded envelope blank formed in accordance with the teachings of this invention;

FIG. 6 is a top plan view of a partially folded envelope blank having the heart shaped configuration;

FIG. 7 is a perspective view of the arrangement depicted in FIG. 6;

FIG. 8 is a top plan view of a substantially folded envelope blank;

FIG. 9 is a perspective view of the substantially folded envelope blank;

FIG. 10 is a top plan view of a completely folded envelope blank;

FIG. 11 is a perspective view of the completely folded envelope blank;

FIG. 12 is a top plan view of an unfolded envelope blank having an alternate folding pattern;

FIG. 13 is a perspective view of the resulting configuration produced by the alternate folding pattern;

FIG. 14 is a template envisioned to produce different sized envelope blanks.

FIG. 15 is a top plan view of an unfolded envelope blank that has undergone an additional method step;

FIG. 16 is a top plan view of the substantially folded envelope blank of FIG. 15; and

FIG. 17 is a top plan view of the partially folded envelope blank of FIG. 15.

### DETAILED DESCRIPTION OF THE INVENTION

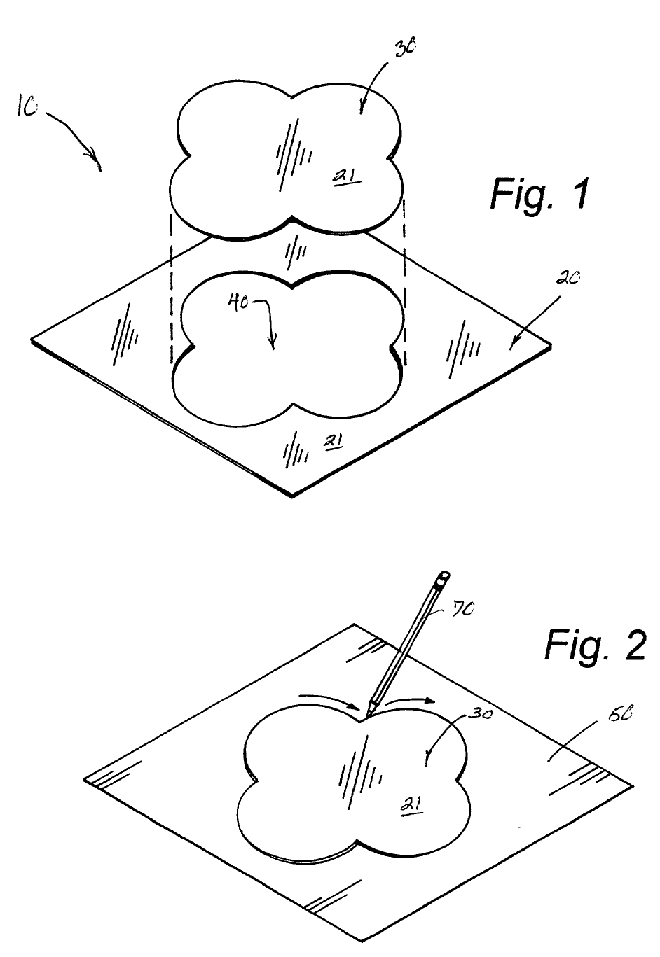

As can be seen by reference to the drawings, and in particular to FIG. 1, the preferred form of the template unit that forms the basis of the present invention is designated generally by the reference number 10. The template unit 10 comprises a generally rectangular sheet 20 of thin plastic material 21 from which a generally cruciform shaped portion has been removed to produce a positive template member 30 whereas the cruciform shaped aperture 40 in the sheet of plastic 20 comprises a negative template.

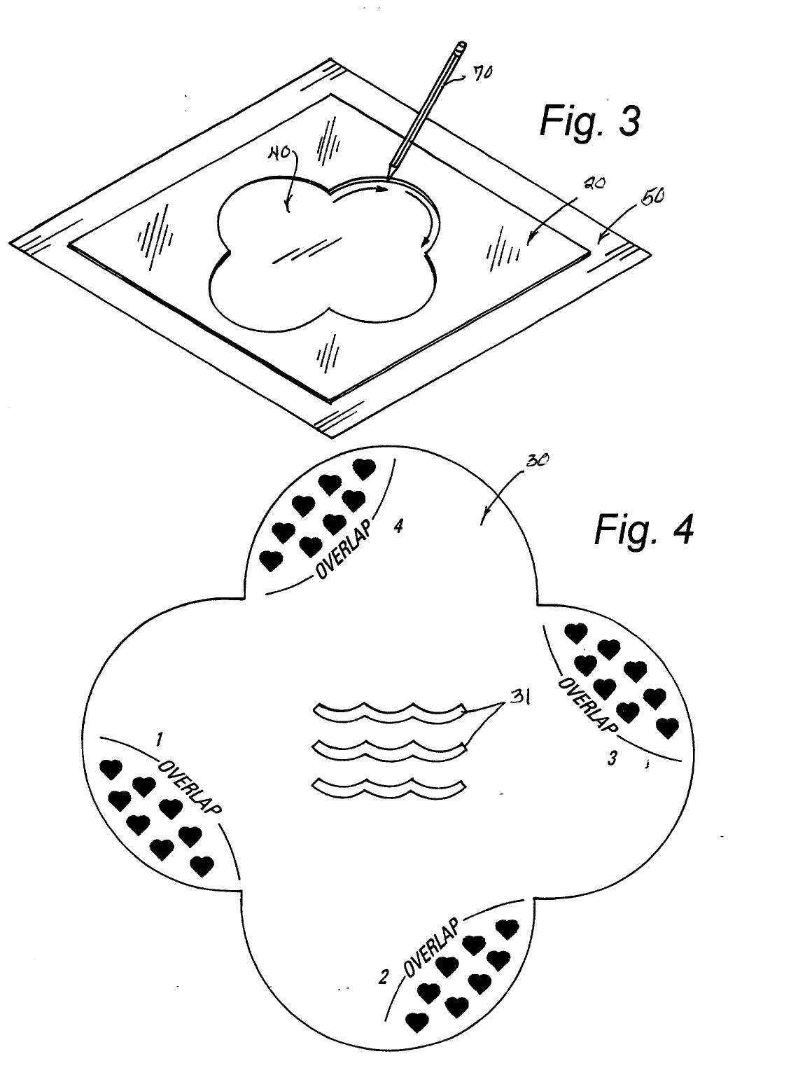

As shown in FIG. 2, the positive template 30 is placed on a sheet of paper 50 and a pencil 70 is used to trace the outline of the positive template 30 on the paper 50. Likewise, as shown in FIG. 3, the negative template 20 is placed on a sheet of paper and a pencil 70 is used to follow the outline of the cruciform shaped aperture 40 that remains in the plastic sheet 20 after the positive template 30 has been removed.

FIG. 4 shows a modified version of the positive template 30 wherein the center portion of the positive template is provided with a plurality of slots 31 that can be used to form light pencil lines on the front face 51 of the finished envelope for the recipient's name and address.

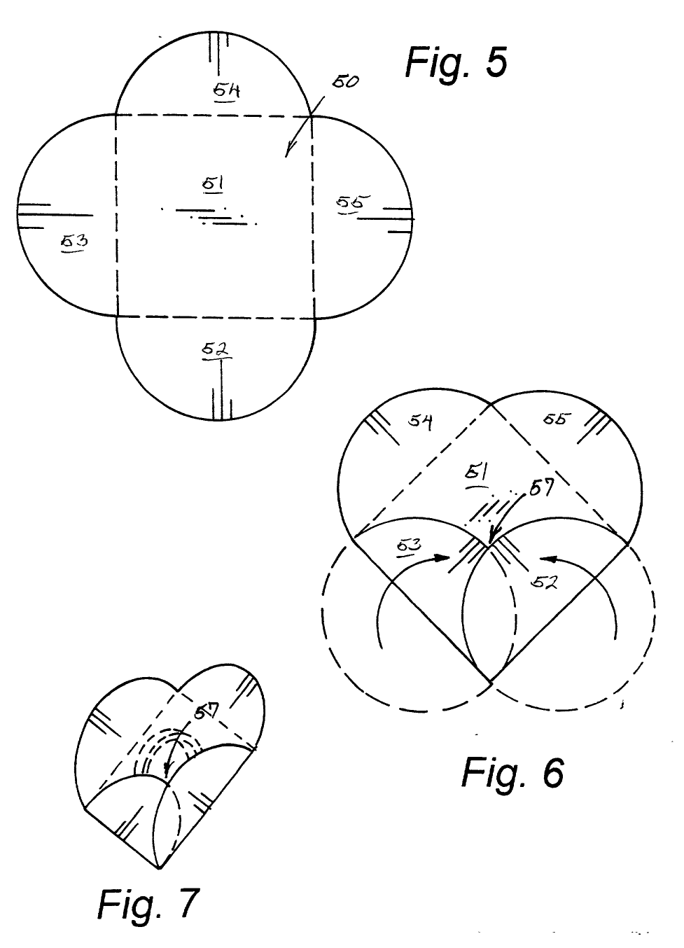

At this juncture, it should noted that when a pencil 70 is used to trace the cruciform outline on a sheet of paper 50, that outline will have to be severed by using a conventional pair of scissors or other cutting implement (not shown) to create the envelope blank 50 depicted in FIG. 5. However, if a scalpel or Exacto blade 80 is substituted for the pencil 70, the tracing and severing process can be combined into a single step.

Turning now to FIGS. 5 through 7, it can be seen that the envelope blank 50 has a square central section 51 that will form the face of the finished envelope. In addition, the central section 51 is surrounded by four mirror image rounded arm flaps 52 through 55 having a generally semi-circular configuration.

When two of the adjacent arm flaps 52 53 are folded inwardly toward the central section 51 and are glued to one another, a heart shaped configuration results as shown in FIGS. 6 and 7; and the flaps 52 53 further cooperate with the central section 51 to form a pocket 57 for storing a keepsake such a picture, a lock of hair, etc. This configuration alone can serve as an aesthetically pleasing heart shaped embellishment for a card or scrapbook page.

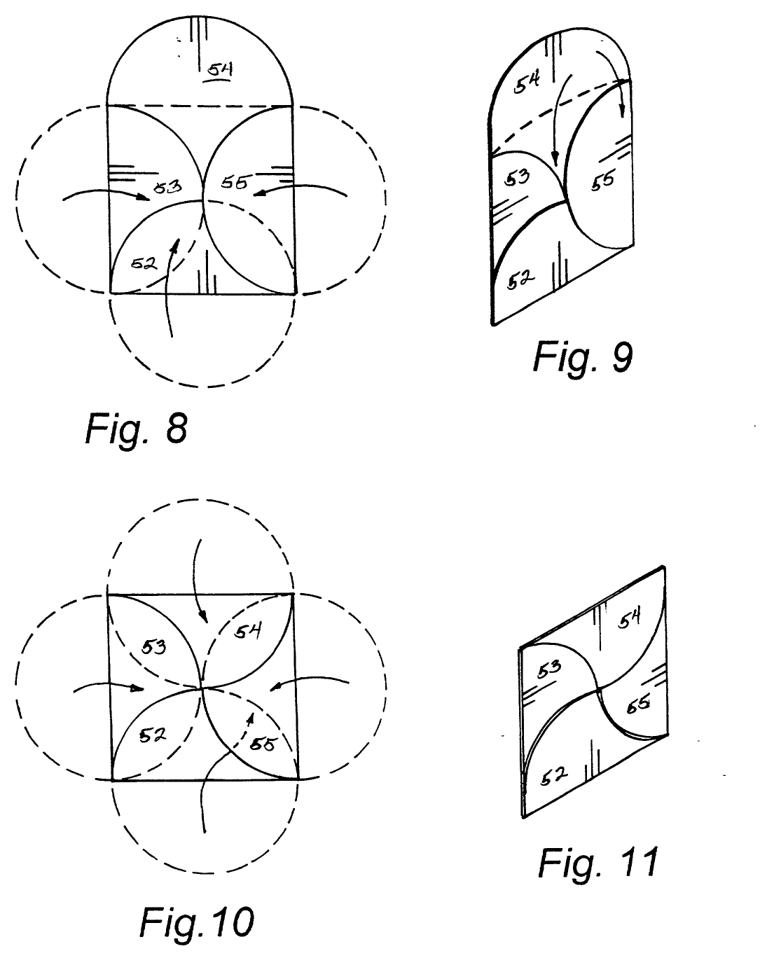

Turning now to FIGS. 8 through 11, it can be seen that a specific folding pattern of the arm flaps 52 through 55 can also produce an aesthetically pleasing appearance for the back of the finished envelope. This folding pattern can be accomplished without the benefit of adhesives and involves folding successive arm flaps 53 52 55 and 54 on top of one another with the last arm flap 54 being tucked under the first arm flap 53 to produce a “yin yan” effect on the back of the envelope.

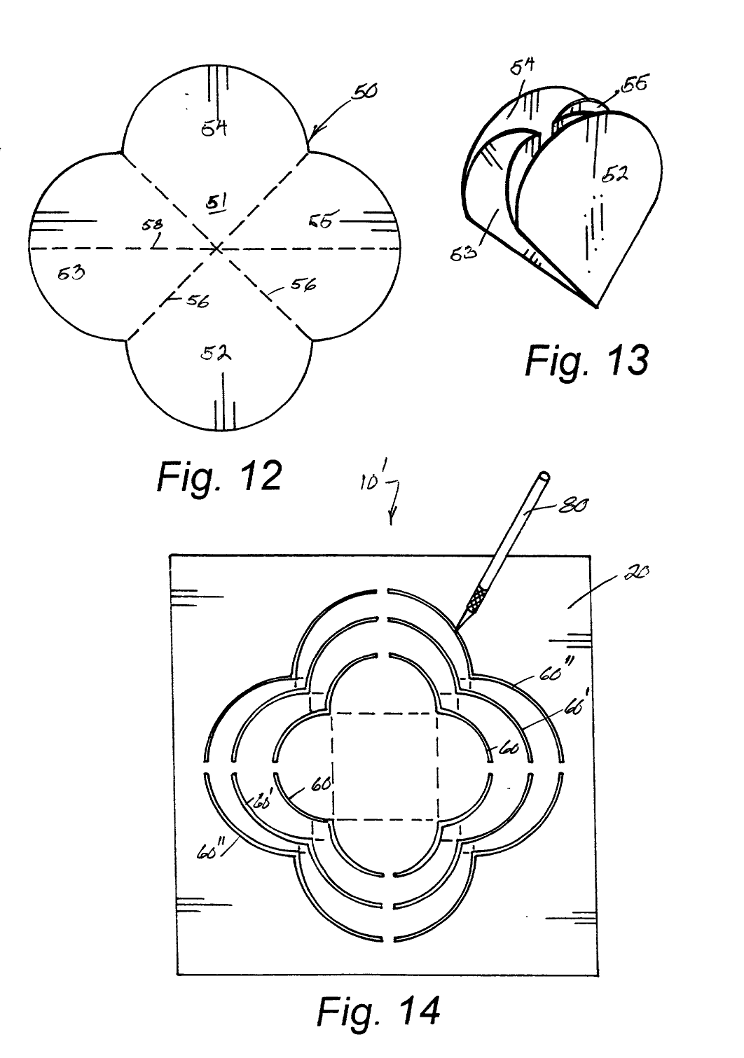

As shown in FIGS. 12 and 13, another folding pattern of the envelope blank 50 will produce yet another uniquely shaped envelope or receptacle as will now be explained. As indicated by the dashed lines in FIG. 12, diagonal creases 56 are formed across the square central section 61 and then the envelope blank 50 is folded in half along the crease 58.

Once this creasing has been accomplished, the crease 58 which bisects arm flaps 53 and 55 is forced inwardly to produce the envelope or paper receptacle depicted in FIG. 13, which resembles an ice cream cone or balloon configuration.

In the alternate version of the template unit 10′ depicted in FIG. 14, the sheet of plastic 20 is provided with a series of generally concentrically aligned discontinuous slots 60 60′ 60″ wherein each series of slots defines the substantial outline of different sized cruciform envelope blanks that may be severed from a sheet of paper (not shown) by a severing blade 80 in a well recognized manner.

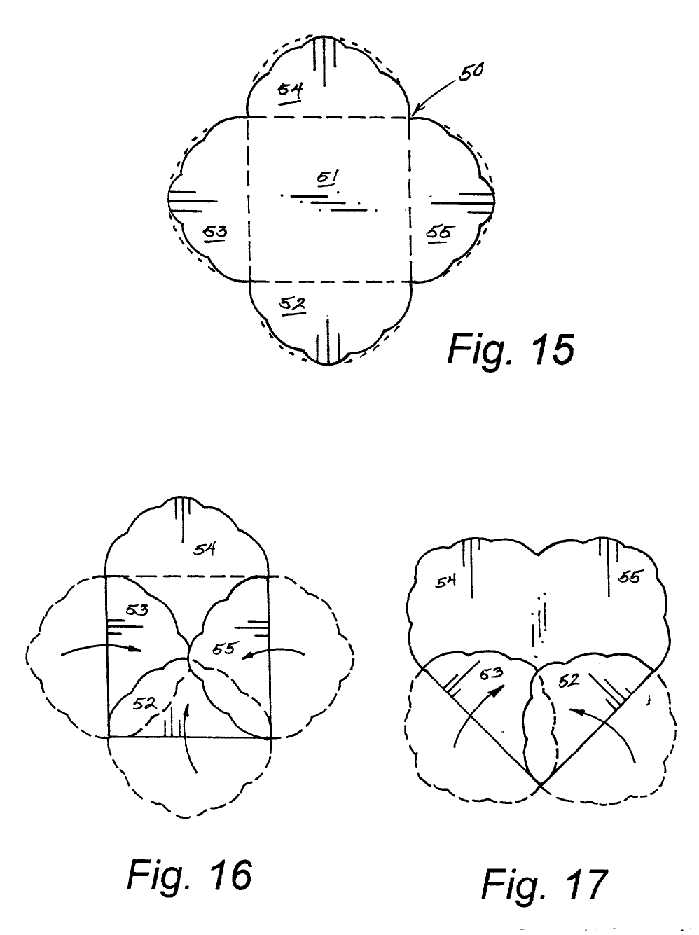

In yet another embodiment of this invention illustrated in FIGS. 15 through 17, an additional cutting step can be employed to produce a generally flower shaped envelope blank 50 wherein the outer edges of the arm flaps 52 through 55 are trimmed by pinking shears (not shown) to produce a ruffled edge flower outline. Returning once more to FIGS. 4 and 5, it should be noted that each of the semi-circular shaped arm flaps 52 through 55 must have a diameter equal to the length of each side of the square central section 51 in order to produce the desired heart shaped configuration of the partially folded envelope depicted in FIGS. 6 and 7.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A template unit for producing heart shaped envelopes wherein the template unit comprises
a sheet of thin flat material having a surface whose perimeter defines a generally cruciform configuration having a square central section and four rounded arm flaps projecting outwardly from the four sides of the square central section.

2. The template unit as in claim 1; wherein, the surface whose perimeter defines said generally cruciform configuration comprises the external perimeter of the sheet of material.

3. The template unit as in claim 1; wherein, the sheet of material has an enlarged contoured aperture whose internal perimeter defines said generally cruciform configuration.

4. The template unit as in claim 1; wherein, said sheet of material has at least one series of discontinuous contoured slots whose openings cooperate with one another to define said generally cruciform configuration.

5. An envelope blank for forming a heart shaped envelope wherein said blank comprises
a sheet of paper having a square central section and four curved arm flaps projecting outwardly from the four sides of the square central section.

6. The envelope blank as in claim 5; wherein, each of said curved arm flaps have a generally semi-circular configuration.

7. The envelope blank as in claim 6; wherein, the diameter of each of the semicircular arm flaps is equal to the length of each side of the square central section.

8. A method of making a variety of uniquely shaped envelopes from a sheet of paper comprising the steps of
a) placing a template having a surface whose perimeter defines a generally cruciform configuration including a square central section and four rounded arm flaps projecting outwardly from the four sides of the square central section on top of a sheet of paper
b) employing a severing implement to follow said surface on the template that defines the generally cruciform configuration to sever the sheet of paper to create an envelope blank having the generally cruciform configuration; and,
c) creasing and folding said envelope blank in a particular sequence to create a paper receptacle having a given configuration.

9. The method as in claim 8; wherein, said particular sequence involves the steps of:
d) folding two adjacent arm flaps toward the square central section; and,
e) securing said two adjacent arm flaps together to form a heart shaped paper receptacle.

10. The method as in claim 8; wherein, said particular sequence involves the steps of:
f) folding the four arm flaps in a sequential fashion against the square central section; and,
g) tucking the last folded arm flap beneath the first folded arm flap to create a square paper envelope having a rear face that resembles a “yin yan” symbol.

11. The method as in claim 8; wherein, said particular sequence involves the steps of:
h) creating diagonal creases across the square central section
i) folding the envelope blank in half to create a central crease that bisects two opposed arm flaps; and,
j) folding said bisected opposed arm flaps toward one another to create a paper receptacle having an ice cream cone shaped configuration.

12. The method as in claim 8; further including an intermediate step after step b) which comprises the step of:
k) using pinking shears to create ruffled edges on all of the rounded arm flaps to produce an envelope blank having a flower shaped configuration.
